(19) United States
(12) Patent Application Publication
(10) Pub. No.: US 2007/0283603 A1
(43) Pub. Date: Dec. 13, 2007

(54) GREETINGS BOOK

(76) Inventor: Tony Haynes, Van Nuys, CA (US)

Correspondence Address: SOMMER BARNARD ATTORNEYS,P.C., ONE INDIANA SQ, SUITE 3500, INDIANAPOLIS, IN, 46204, US

(21) Appl. No.: 11/733,915

(22) Filed: Apr. 11, 2007

Related U.S. Application Data
(63) Continuation-in-part of application No. 10/769,724, filed on Feb. 2, 2004, now abandoned.

(51) Int. Cl. G09F 19/00

(52) U.S. Cl. 40/533

(57) ABSTRACT

An organized, efficient and aesthetically pleasing multi-greeting card package. In one form, the package is a greeting card book including a binding element and a plurality of cards. Each of the plurality of cards includes a bottom portion, a top portion and a fold seam between the top and bottom portions. The bottom portion has an edge removably bound to the binding element such that when the bottom portion is bound to the binding element, the top portion is pivotal at the fold seam between a first folded position, wherein the top portion overlies the bottom portion, and a second extended position, wherein the top portion is pivoted away from the bottom portion.

### PRIORITY REFERENCE

This application is a continuation-in-part of pending U.S. patent application Ser. No. 10/769,724 entitled GREETINGSBOOK and filed on Feb. 2, 2004 in the name of Tony Ray Haynes.

### BACKGROUND

The present invention relates to the Greeting Card industry and, more particularly, to multi-greeting card packs.

Traditionally, greeting cards have been sold individually. Consumers are faced with numerous choices and must pick and purchase each greeting card individually. Such a task can be somewhat cumbersome when a consumer needs to purchase multiple greeting cards. To simplify this task, some greeting cards have been packed in multiples and sold. These multi-packs usually include a stack of loose envelopes and a stack of loose greeting cards placed atop the stack of envelopes. The stacks of envelopes and greeting cards are either shrink-wrapped together or are sealed in a box. Once opened, the cards are loose and unorganized. It can be difficult for the consumer to view and store the cards. Furthermore, the consumer does not get much pleasure from viewing the loose, duplicate cards. In addition, these multi-packs, traditionally have contained only duplicates of the same card and have been limited to thank you cards and invitations.

Poetry books have been enjoyed by many. Poetry books typically include multiple bound pages, each page containing a different poem or inspirational message and, in many cases, artwork. The consumer can effortlessly flip through each page and enjoy the poetry and artwork. Unfortunately, it can be difficult to share the beauty of this poetry and artwork with others. The pages are not easily removable and are not in a form conducive to sending to friends or family. Greeting cards often include poetry and inspiration messages, and consumers have relied on greeting cards to share an inspiration message with friends and family. However, as discussed above, these cards are either sold individually or in multi-packs that have not been in a form that is organized, easy to use and conducive to the consumer's enjoyment.

Accordingly, a need remains for a greeting card package that includes a plurality of greeting cards in an organized, viewable fashion.

### SUMMARY

The present invention provides an organized, efficient and aesthetically pleasing multi-greeting card package. In one form, the invention provides a greeting card book including a binding element and a plurality of cards. Each of the plurality of cards includes a bottom portion, a top portion and a fold seam between the top and bottom portions. The bottom portion has an edge removably bound to the binding element such that when the bottom portion is bound to the binding element, the top portion is pivotal at the fold seam between a first folded position, wherein the top portion overlies the bottom portion, and a second extended position, wherein the top portion is pivoted away from the bottom portion.

In another form, the present invention provides a greeting card book including a binding element and a plurality of cards, each of the plurality of cards including a bottom portion, a top portion and a fold seam between the top and bottom portions. Each of the plurality of cards includes a first edge extending along the length of both the top and bottom portions. The first edge has a bound section extending along the length of the bottom portion and a free section extending along the length of the top portion. The bound section is removably bound to the binding element, while the free section being free of the binding element. When the bottom portion is bound to the binding element, the top portion is pivotal at the fold seam between a first folded position, wherein the top portion overlies the bottom portion, and a second extended position, wherein the top portion is pivoted away from the bottom portion.

In yet another form, the present invention provides a greeting card book including a binding element, a plurality of cards, a plurality of envelopes and a cover. Each of the plurality of cards includes a bottom portion, a top portion and a fold seam between the top and bottom portions. The fold seam pivotally couples the top portion to the bottom portion. The bottom portion has an edge removably bound to the binding element, while the top portion is free of the binding element. The each of the plurality of envelopes is configured to receive one of the plurality of cards. The cover is coupled to the binding element and at least partially encloses the plurality of cards. The cover has a pocket configured to store the plurality of envelopes. When the bottom portion is bound to the binding element, the top portion is pivotal at the fold seam between a first folded position, wherein the top portion overlies the bottom portion, and a second extended position, wherein the top portion is pivoted away from the bottom portion.

This invention fulfills a need for the consumer to have the ability to purchase several greeting cards at once with a cohesive concept. It's an experience similar to buying an album from your favorite music artist. Instead of purchasing a “single” (One Greeting Card), you can now buy the collection (8 to 28 cards). Each card can vary in message and artwork, and can be sent to others one-by-one. In the meantime, the consumer can enjoy the GreetingsBook as a poetry book. Alternatively, the consumer, if he or she chooses, can simply keep the GreetingsBook and cherish the pages, and be comforted by the poetry and pictures. Every day millions of people purchase greeting cards. I am one of those people. One day, I thought to myself, that there should be more than just individual greeting cards out there. There should be a product that can be both a greeting cards and a book. I'm a little guy. I saw a void. So, I invented the GreetingsBook. Sure there are blank notebooks where the consumer can write his and her thoughts. There are spiral bound notebooks with lines and really thin perforated pages for middle school, high school and college students. And there are greeting cards in the traditional sense. This invention provides an outlet other than the traditional single greeting card. It's a stand alone product that won't get lost among hundreds of individual greeting cards or multiple, duplicate loose cards.

Here's my 4 line poetic summarization.

“Tear it, read it, share it, Fold it, hold it, make a stack, Stuff it into an envelope Provided in the back!”

What Prevails When All Else Fails?“Poetry Works . . . The GreetingsBook.

And that's what's missing in our lives. The poetry. This product gives people a chance to share the poetry of life. Simplistically.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a perspective view of a greeting card book in accordance with one embodiment of the present invention;

FIG. 2 is a perspective view of the greeting card book of FIG. 1 wherein a card of the book is in the open position;

FIG. 3 is a perspective view of the greeting card book of FIG. 1 wherein the cards of the book are turned toward the front cover to reveal the envelope pocket;

FIG. 4 is a perspective view of a greeting card book in accordance with another embodiment of the present invention;

FIG. 5 is a front view of a greeting card book in accordance with another embodiment of the present invention;

FIG. 6 is a back view of the greeting card book of FIG. 5; and

FIG. 7 is a view of the back cover of the greeting card book of FIG. 5.

Corresponding reference characters indicate corresponding parts throughout the several views. Although the drawings represent embodiments of the present invention, the drawings are not necessarily to scale and certain features may be exaggerated in order to better illustrate and explain the present invention. Although the exemplification set out herein illustrates embodiments of the invention, in several forms, the embodiments disclosed below are not intended to be exhaustive or to be construed as limiting the scope of the invention to the precise forms disclosed.

### DETAILED DESCRIPTION

The embodiments hereinafter disclosed are not intended to be exhaustive or limit the invention to the precise forms disclosed in the following description. Rather the embodiments are chosen and described so that others skilled in the art may utilize its teachings.

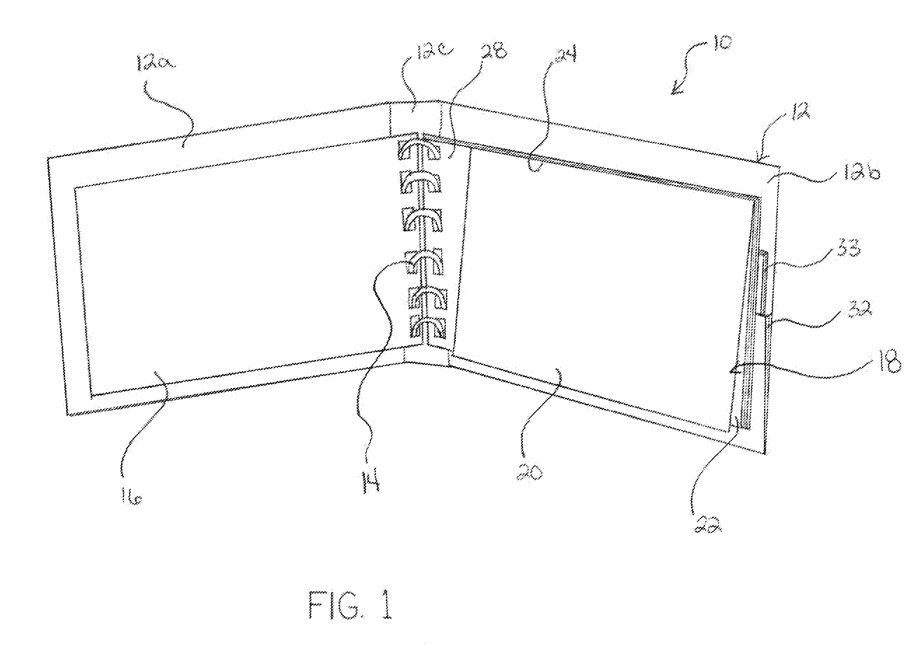

Referring first to FIGS. 1-3, greetings book 10, in accordance with one embodiment of the present invention, is illustrated. Greetings book 10 generally includes cover 12, binding element 14 coupled to cover 12, plurality of cards 18 coupled to binding 14 and plurality of envelopes 33. More particularly, cover 12 includes front cover 12a, back cover 12b and spine 12c. Front cover 12a, back cover 12b and spine 12c cooperate to at least partially enclose and protect cards 18. Back cover 12b includes pocket 32 which is sized and configured to store envelopes 33. Cover 12 may be formed of any suitable material including, for example, plastic, paper, card board or fabric. In one embodiment, cover 12 is formed of a transparent, semi-rigid plastic, which protects cards 18 and envelopes 33 and through which cards 18 are viewable. Pocket 32 is illustrated as an expandable, flexible pocket attached to back cover 12b. However, it should be understood that pocket 32 may take any shape and form and may be attached to other portions of cover 12.

Referring still to FIGS. 1-3, binding 14 is in the form of a spiral binding which extends through spine 12c in a typical fashion to couple spiral binding 14 to cover 12. It should be understood that the present invention may employ any binding capable of binding cards 18 including, for example, adhesive book binding strips and rings.

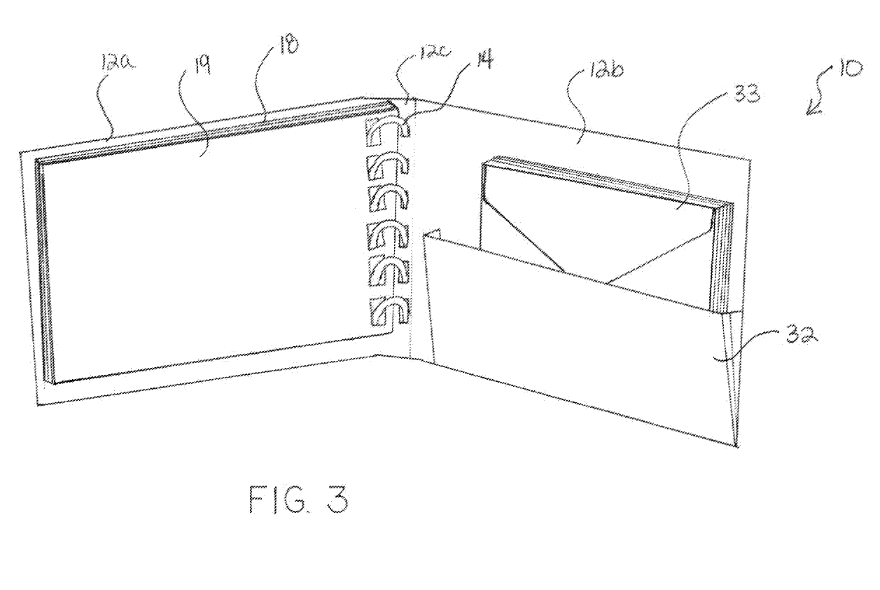

As illustrated in FIGS. 1 and 3, greetings book 10 may include cover page 16 and back page 18, which may further protect cards 18 and may include information such as the author of the poetry in cards 18, and artist of any artwork. Cover page 16 and back page 18 may also include notation lines, calendars and/or charts in which the recipient of cards 18 and dates may be entered. It should be understood that although the embodiment shown in FIGS. 1-3 includes cover and back pages 16, 18, such pages may be omitted. On the other hand, the invention also contemplates that additional pages may be added to greetings book 10. Furthermore, cover and/or back pages 16, 18 may serve as the cover and pocket 32 may be affixed to back or cover pages 16, 18.

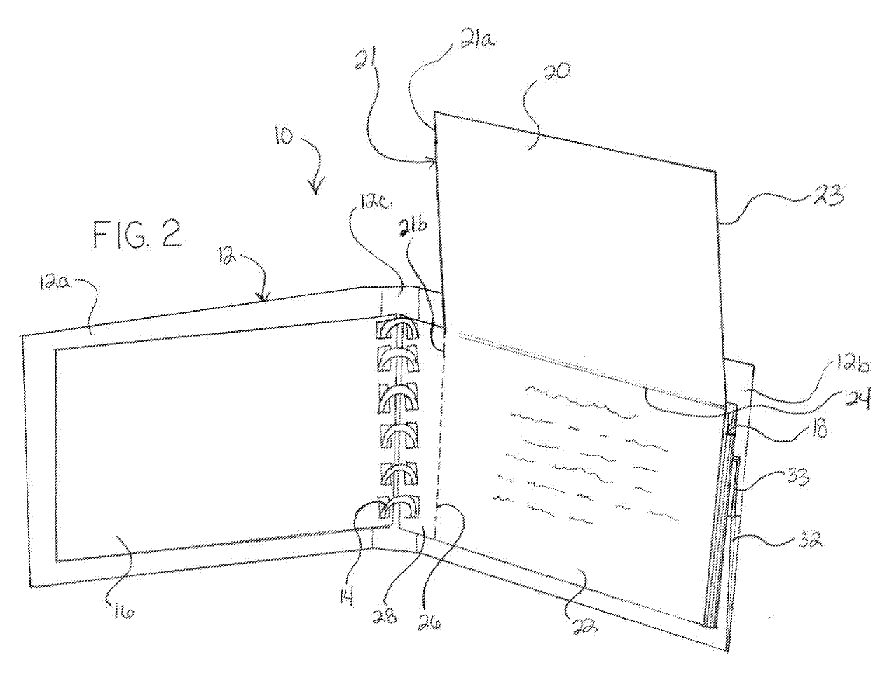

Turning now to FIGS. 1 and 2, each of cards 18 includes a card body including top free portion 20, bottom bound portion 22 and fold seam 24 extending between top and bottom portions 20, 22. As discussed in further detail below, fold seam 24 provides a pivot point about which top portion 20 can pivot relative to bottom portion 22 such that top portion 20 may be folded over to overly bottom portion 22. Top and bottom portions 20, 22 are defined on opposing sides by first and second edges 21, 23, respectively, which extend the length of both top and bottom portions 20, 22. First edge 21 includes free section 21a, which extends along the side of top portion 20, and bound section 21b, which extends along the side of bottom portion 22. Each of cards 18 includes tab portion 28, which is coupled at one edge to binding 14. At its opposite edge, tab portion 28 is removably coupled to bound section 21b of first edge 21, such that bottom portion 22 is removably bound to binding 14 through tab portion 28. Perforation line 26 is provided at the union of tab portion 28 and bottom portion 22 to facilitate the removal of card 18. Perforation line 26 enables the easy tearing away of card body from binding 14. Although the embodiments illustrated and thus far described show a perforation line, a score line could be used in the alternative. Furthermore, it should be understood that cards 18 need not necessarily include tab portion 28. Rather, bound section 21b of first edge 21 could be directly, removably coupled to binding 14, particularly, in the case of an adhesive book binding.

As illustrated in FIGS. 1 and 2 and discussed above, only bound section 21b of first edge 21 is bound to binding 14 (via tab portion 28), while free section 21a of first edge 21 is free of binding 14 (and of tab portion 28). Accordingly, while bottom portion 22 is bound to binding 14, top portion 20 is pivotal between a first folded position, shown in FIG. 1, and a second extended position, shown in FIG. 2. As shown in FIG. 1, in the first folded position, top portion 20 overlies bottom portion 22 such that cards 18 can be stacked atop one another and enclosed in cover 20. In addition, in the first folded position, the front of top portion 20, where artwork and wording may be placed, is visible to the user. In the second extended position, shown in FIG. 2, the interior of the card may be viewed by the user while the cards are still stacked and bound to binding 14.

In operation, a user purchases greeting book 10 and can flip through book 10 enjoying each of cards 18 as he would the pages of a poetry book. Each of cards 18 may be viewed first in the folded position shown in FIG. 1, so that the images and wording on the front face of the card may be viewed. Then top portion 20 is pivoted at fold seam 24 to the extended position shown in FIG. 2 so that the interior of the card may be read and viewed. In addition to enjoying cards 18, himself, the consumer may detach cards 18 and send to others. The user would simply tear card 18 at perforation 26, thereby pulling bottom portion 22 from tab portion 28 and detaching card 18 from binding 14. The user can then write a personal greeting and/or sign card 18 as he would any greeting card. The user then removes one of envelopes 33 from pocket 32 (FIG. 3), addresses envelope 33, inserts card 18 in envelope 33 and sends the card to the intended recipient. The user can then simply close book and stow away, thereby neatly storing and organizing cards for later viewing and use.

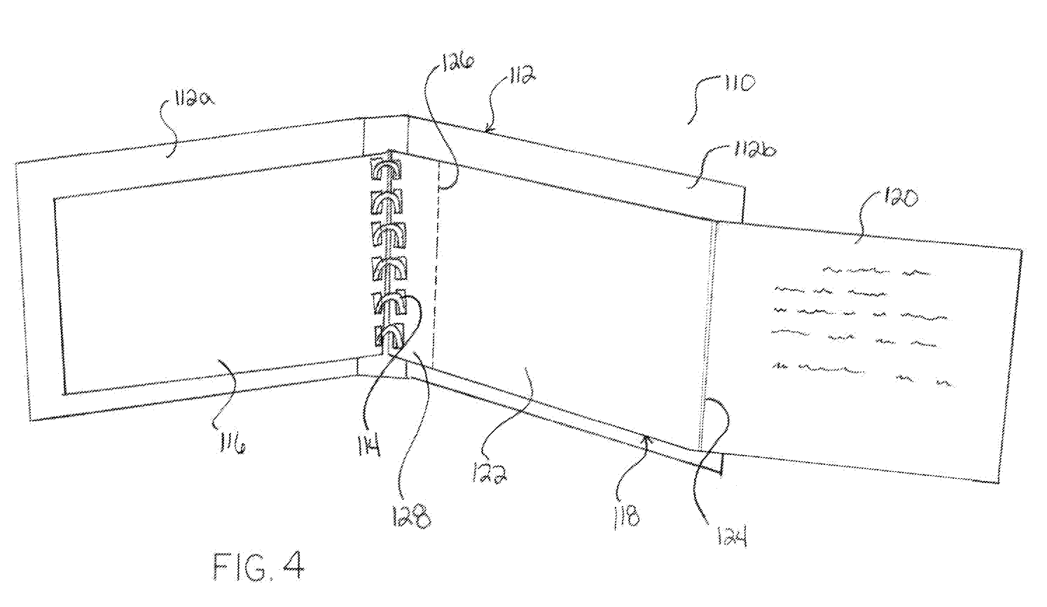

Turning now to FIG. 4, another embodiment of the present invention is illustrated. Greetings book 110 includes cover 112, binding 114 and plurality of cards 118. Greetings book 110 may also include cover page 116. Cover 112 includes front portion 112a, back portion 112b and spine 112c. Binding 114 is coupled to spine 112c. Each of cards 118 includes a top portion 120, bottom portion 122 and fold seam 124 extending between top and bottom portions 120, 122. Card 118 may be folded at fold seam 124 such that top portion 120 overlies bottom portion 122. Card 118 also includes tab portion 128, which is coupled at one side to binding 114 and is couple at the other side to bottom portion 122. Tab portion 128 and bottom portion 122 are coupled at perforation line 128, which facilitates the tearing away of bottom portion 122 from tab portion 128. As illustrated in FIG. 4, while cards 18 are coupled to binding 114 (via tab portion 128) top portion 120 may be pivoted away from bottom portion 122 so that the interior of card 118 may be viewed while cars 118 are neatly organized in book 110.

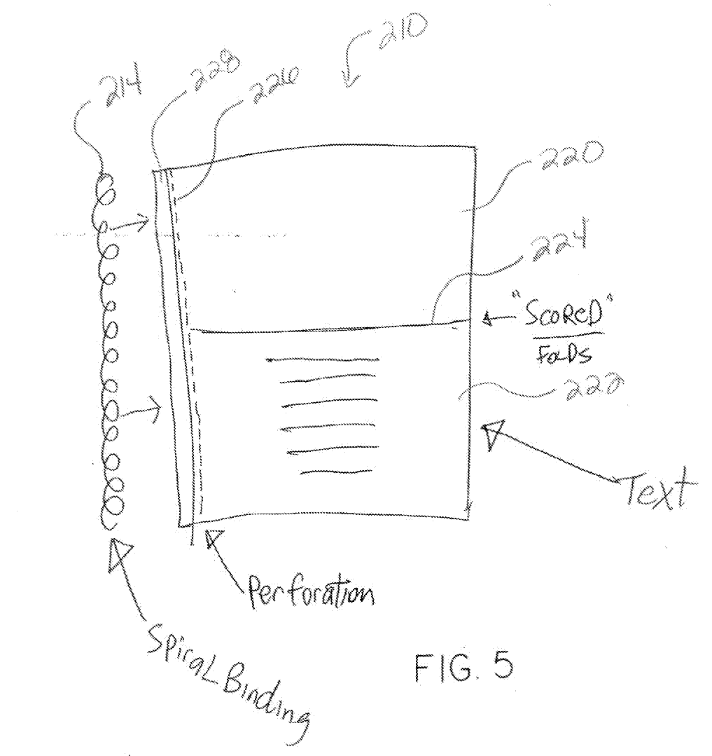

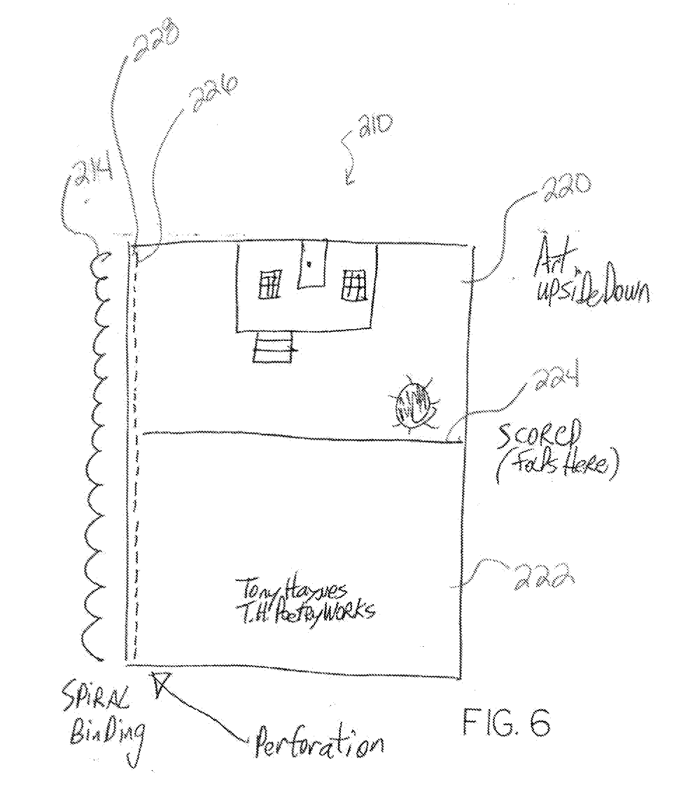

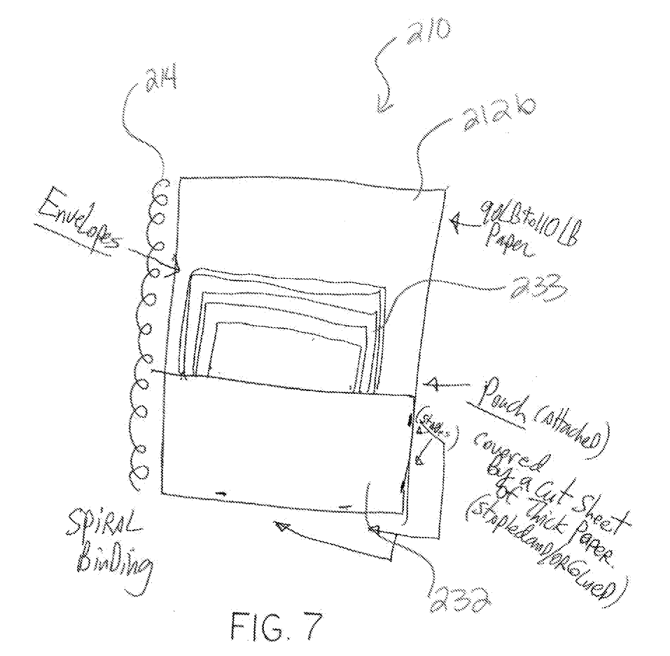

Turning now to FIGS. 5-7, another embodiment of the greetings book is illustrated. Greetings book 210 includes back cover 212b, binding 214 and plurality of cards 218. Each of cards 218 includes a top portion 220, bottom portion 222 and fold seam 224 extending between top and bottom portions 220, 222. Card 218 also includes tab portion 228, which is coupled at one side to binding 214 and is couple at the other side to top and bottom portions 220, 222. Tab portion 228 is coupled to top and bottom portions 220, 222 at perforation line 228, which facilitates the tearing away of card 218 from binding 214 and tab portion 228. Back cover 212b includes pocket 232, which stores envelopes 233. In use, cards 218 may be detached from binding 214 by tearing at perforation line 226. Once removed, cards 218 may be folded at fold seam 224 to form a traditional folded card.

In one particular variation of the embodiment of FIGS. 5-7, the greetings book includes is formed by taking 10-to-30 sheets of thick paper, 90 lb, or greater and sized 8½″ By 11″ or smaller. All pages, excluding the cover page, back cover page, pouch page and table of contents are perforated, so that these pages can be torn out neatly. These pages are also ‘scored’, so they can be folded in half and create a greeting card if the user decides to tear them out of the greetings book. These 10 to 30 sheets of paper are then stacked together. An additional sheet of thick paper is now added and placed just ahead of the back cover page. This sheet has a pouch. Envelopes are placed in the pouch. The amount of envelopes ranges from 8 to 30, depending on the amount of perforated & scored pages within the greetings book. After the additional sheet with pouch is added, all of the elements are spiral bound. Now we have a complete greetings book. The perforated pages within the greetings book have text at the bottom portion of the page below the scored section. The top of the page is blank. On the backside, the top of each page displays the artwork. Inside of the greetings book, the artwork appears upside down. This way, when the perforated page is torn out and it is folded at the point where it is scored, it will be come a greeting card complete with art. The bottom portion of the backside of the page has company info, attribution and copyright statements.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A greeting card book comprising:
a binding element; and
a plurality of cards, each of said plurality of cards including a bottom portion, a top portion and a fold seam between said top and bottom portions, said bottom portion having an edge removably bound to said binding element;
wherein, when said bottom portion is bound to said binding element, said top portion is pivotal at said fold seam between a first folded position, wherein said top portion overlies said bottom portion, and a second extended position, wherein said top portion is pivoted away from said bottom portion.

2. The greeting card book of claim 1 wherein each of said plurality of cards includes a tab portion coupled at one end to said binding element and removably coupled at the opposite end to said edge of said bottom portion, said edge of said bottom portion is removably bound to said opposite end of said tab portion by a perforation.

3. The greeting card book of claim 1 wherein each of said plurality of cards includes a tab portion coupled at one end to said binding element and removably coupled at the opposite end to said edge of said bottom portion, said edge of said bottom portion is removably bound to said opposite end of said tab portion by a score.

4. The greeting card book of claim 1 wherein said binding element is in the form of a spiral binding.

5. The greeting card book of claim 1 wherein said binding element is in the form of an adhesive strip.

6. The greeting card book of claim 1 wherein each of said plurality of cards bears a different message.

7. The greeting card book of claim 1 further comprising a cover, said cover including a pocket.

8. The greeting card book of claim 7 further comprising a plurality of envelopes configured to be stored in said pocket, each of said plurality of envelopes configured to receive one of said plurality of cards.

9. A greeting card book comprising:
a binding element; and
a plurality of cards, each of said plurality of cards including a bottom portion, a top portion and a fold seam between said top and bottom portions, each of said plurality of cards including a first edge extending along the length of both said top and bottom portions, said first edge having a bound section extending along the length of said bottom portion and a free section extending along the length of said top portion, said bound section being removably bound to said binding element, said free section being free of said binding element;
wherein, when said bottom portion is bound to said binding element, said top portion is pivotal at said fold seam between a first folded position, wherein said top portion overlies said bottom portion, and a second extended position, wherein said top portion is pivoted away from said bottom portion.

10. The greeting card book of claim 9 wherein each of said plurality of cards includes a tab portion coupled at one end to said binding element and removably coupled at the opposite end to said bound section, said bound section is removably bound to said opposite end of said tab portion by a perforation.

11. The greeting card book of claim 9 wherein each of said plurality of cards includes a tab portion coupled at one end to said binding element and removably coupled at the opposite end to said bound section, said bound section is removably bound to said opposite end of said tab portion by a score.

12. The greeting card book of claim 9 wherein said binding element is in the form of a spiral binding.

13. The greeting card book of claim 9 wherein said binding element is in the form of an adhesive strip.

14. The greeting card book of claim 9 wherein said binding element is in the form of ring bindings

15. The greeting card book of claim 9 further comprising a cover, said cover including a pocket.

16. The greeting card book of claim 15 further comprising a plurality of envelopes configured to be stored in said pocket, each of said plurality of envelopes configured to receive one of said plurality of cards.

17. A greeting card book comprising:
a binding element;
a plurality of cards, each of said plurality of cards including a bottom portion, a top portion and a fold seam between said top and bottom portions and pivotally coupling said top portion to said bottom portion, said bottom portion having an edge removably bound to said binding element, said top portion being free of said binding element;
a plurality of envelopes each configured to receive one of said plurality of cards; and
a cover coupled to said binding element and at least partially enclosing said plurality of cards, said cover having a pocket configured to store said plurality of envelopes;
wherein, when said bottom portion is bound to said binding element, said top portion is pivotal at said fold seam between a first folded position, wherein said top portion overlies said bottom portion, and a second extended position, wherein said top portion is pivoted away from said bottom portion.

18. The greeting card book of claim 18 wherein each of said plurality of cards includes a tab portion coupled at one end to said binding element and removably coupled at the opposite end to said bottom portion, said bottom portion is removably bound to said opposite end of said tab portion by a perforation.

19. The greeting card book of claim 18 wherein said binding element is in the form of a spiral binding.

20. The greeting card book of claim 18 wherein said binding element is in the form of an adhesive strip.
